(19) United States
(12) Patent Application Publication
(10) Pub. No.: US 2011/0273907 A1
(43) Pub. Date: Nov. 10, 2011

(54) PLANAR LIGHTING DEVICE

(76) Inventor: Osamu IWASAKI, Kanagawa (JP)

(21) Appl. No.: 13/103,295

(22) Filed: May 9, 2011

(30) Foreign Application Priority Data
May 10, 2010 (JP) 2010-108029

(51) Int. Cl. F21V 8/00

(52) U.S. Cl. 362/607

(57) ABSTRACT

A planar lighting device using a large and thin light guide plate and yet capable of yielding a high light use efficiency, emitting light with a minimized unevenness in luminance, and guiding the admitted light deep into the light guide plate to achieve a uniform or convex luminance distribution, i.e., a distribution curve that is high in a range near the middle of the screen as compared with the peripheral area of the screen. The light guide plate is provided on its rear side, or on the side thereof closer to the light exit plane, or on both sides in a given pattern with a distribution density changing continuously so as to once decrease with the increasing distance from the light entrance plane, and then increase with the increasing distance.

### BACKGROUND OF THE INVENTION

The present invention relates to a planar lighting device used for a liquid crystal display device and the like.

Liquid crystal display devices use a backlight unit for radiating light from behind the liquid crystal display panel to illuminate the liquid crystal display panel. A backlight unit is configured using a light guide plate for diffusing light emitted by an illumination light source to irradiate the liquid crystal display panel and optical parts such as a prism sheet and a diffusion sheet for rendering the light emitted from the light guide plate uniform.

Currently, large liquid crystal televisions predominantly use a so-called direct illumination type backlight unit comprising a light guide plate disposed immediately above the illumination light source. This type of backlight unit comprises a plurality of cold cathode tubes serving as a light source provided behind the liquid crystal display panel whereas the inside of the backlight unit provides white reflection surfaces to ensure uniform light amount distribution and necessary luminance.

To achieve a uniform light amount distribution with a direct illumination type backlight unit, however, a thickness of about 30 mm in a direction normal to the liquid crystal display panel is required, making further reduction of thickness of the backlight unit difficult using the direct illumination type backlight unit.

Among backlight units that allow reduction of thickness thereof, on the other hand, is a backlight unit using a light guide plate in which light emitted by an illumination light source and entering the light guide plate through a light entrance plane is guided in given directions and emitted through a light exit plane that is different from the plane through which light enters.

There has been proposed a backlight unit of a type in the form of a plate using a light guide plate having a pattern formed on its top surface (light exit plane), the opposite surface thereof (rear plane), or the like for emitting light, wherein light is admitted through a lateral side thereof and allowed to exit through the top surface or a backlight unit of a type using a light guide plate containing scattering particles for diffusing light mixed in a resin, whereby light is admitted through a lateral side and allowed to exit through the top surface.

JP 2003-43266 A, for example, describes a light guide plate having a plurality of dots (dot pattern) provided on a reflection surface (in the rear plane). The dots are arranged so as to form bands of regions each defined as having a given distribution density. In each of the band regions, the dots are so arranged as to form vertical lines substantially at equal intervals running in the direction of adjacent band regions. The distance between the vertical lines formed by the dots in one band region differs from that in the adjacent band regions.

JP 2003-43266 A further describes that the dot distribution density increases with the increasing distance from the light source.

JP 2000-250036 A describes a planar light source device comprising a light guide member having a light extraction mechanism provided on the plane (rear plane) opposite from the light exit plane and dark line prevention mechanisms provided over a distance of at least 1.5 d from a lateral end portion of the light guide member toward the center, where d is the thickness of the light guide member near its light admission portion.

JP 2000-250036 A describes that the dots acting as a light extraction mechanism are so provided that their areas increase as they are farther distanced from the light source. JP 2000-250036 A further describes that the dark line prevention mechanisms are provided in a pattern formed by dots or the like.

JP 2002-258022 A describes a light reflection sheet comprising numerous basic units each formed of a reflection surface having a similar surface to each other provided at a pitch of 5000 μm or less. The basic units have a substantially consistent major reflection direction, the reflection surfaces having a reflectance of 70% or more. Further, the reflection surfaces are each provided thereon with a coating layer made of an optically transparent substance. The surfaces of the coating layers are smooth surfaces.

JP 2002-258022 A describes providing a pattern near a lateral end portion of the light reflection sheet in order to correct bright lines occurring close to the light source in the planar light source device using the above reflection sheet.

As liquid crystal display devices acquire increased dimensions, there are increasing demands for larger backlight units as described above. Accordingly, there have been proposed various backlight units as described above including those of a type having a pattern for emitting light formed on a surface opposite, for example, from the light exit plane, wherein light is admitted through a lateral side thereof and allowed to exit through the light exit plane or those of a type using a light guide plate containing scattering particles for diffusing light mixed therein, whereby light admitted through a lateral plane is guided in a direction different from the direction in which the light has entered and allowed to exit through the light exit plane. Thus, providing a light source on a lateral side of the light guide plate enables reduction in dimensions and weight as compared with backlight units having a light source provided on the reverse side of the light guide plate.

However, when a backlight unit of a type having a pattern formed on a surface opposite, for example, from the light exit plane, is to be made thinner and larger, guiding the admitted light deep into the light guide plate becomes difficult, so that the amount of light emitted through the light exit plane farther from the light entrance plane decreases, producing uneven illuminance distribution (luminance distribution) while reducing the light use efficiency.

Therefore, according to JP 2003-43266 A and JP2000-250036 A, the distribution density of the pattern (dots) is increased as the dots are located farther from the light entrance plane.

Further, when a backlight unit is to be made thinner and larger, the pattern distribution density needs to be reduced in order to guide the admitted light deep into the light guide plate, whereas when the pattern distribution density is small, the admitted light is not diffused sufficiently near the light entrance plane, so that the light leaving the light exit plane may develop visible bright lines (dark lines, unevenness), which are attributable to such causes as space intervals at which the light source units of the light source are disposed, near the light entrance plane.

Therefore, according to JP 2003-43266 A and JP2000-250036 A, the pattern is provided on a part of the light exit plane, etc. close to the light entrance plane to diffuse the light near the light entrance plane to prevent observation of the dark lines.

### SUMMARY OF THE INVENTION

However, when the pattern for emitting light is so formed that the distribution density of the pattern (dots) is increased as the dots are located farther from the light entrance plane, the admitted light is not sufficiently diffused near the light entrance plane because the pattern distribution density there is small, and hence the bright lines attributable to such causes as the space intervals of the light source units may be observable.

In contrast with a configuration where the pattern is provided in a manner as described above, when the pattern is provided on a part of the light exit plane, etc. close to the light entrance plane as in the cases of JP 2000-250036 A and JP 2002-258022 A, the bright lines may be reduced but the luminance distribution (illuminance distribution) of the light emitted through the light exit plane abruptly changes at the edges of the pattern regions, thus failing to achieve a smooth distribution.

An object of the present invention is to overcome the problems associated with the prior art described above and provide a planar lighting device and a method of producing a planar lighting device using a large and thin light guide plate and yet capable of yielding a high light use efficiency, emitting light with a minimized unevenness in luminance, and guiding the admitted light deep into the light guide plate to achieve an even or convex luminance distribution, i.e., a distribution curve that is high in a range near the middle of the screen as compared with the peripheral area of the screen.

To achieve the above object, the planar lighting device comprising: a light guide plate including a light exit plane being rectangular, at least one light entrance plane for admitting light traveling parallel to said light exit plane, said light entrance plane being provided on a side of said light exit plane, and a rear plane opposite to said light exit plane, at least one light source, said light source being disposed facing to said light entrance plane, respectively and transmittance adjusting members distributed in a given pattern on a side of said light guide plate closer to said rear plane or on a side closer to said light exit plane, or on both of these sides, wherein a distribution density of said transmittance adjusting members continuously changes in such a way that said distribution density once decreases with an increasing distance from said light entrance plane, and then increases with the increasing distance.

In this case, it is preferred that said distribution density of said transmittance adjusting members has a minimum value at a position farther from said light entrance plane than a position where said distribution density has a maximum value.

Further, it is preferred that said transmittance adjusting members are not distributed in a region extending a given distance from an end of said light entrance plane of said light guide plate in a direction normal to said light entrance plane.

In this case, it is preferred that said given distance is 30 mm or more.

Further, it is preferred that each of said transmittance adjusting members has an area of 0.1 mm² or less.

Further, it is preferred that said transmittance adjusting members are distributed in a random pattern.

Further, it is preferred that said light guide plate contains scattering particles dispersed therein.

Further, it is preferred that it is to satisfy inequality

1.1≦Φ·Nₚ·L_{G}·K_{C}≦8.2,

where Φ is a scattering cross section of said scattering particles dispersed in said light guide plate, Nₚ is a particle density, L_{G} is a light guiding length in a light's incident direction, and K_{c} is a correction coefficient, provided that K_{c} is in a range of 0.005 inclusive to 0.1 inclusive.

Further, it is preferred that said light guide plate comprises a plurality of layers superposed on each other in a direction normal to said light exit plane and having different densities of said scattering particles.

Further, it is preferred that said light guide plate has a thickness of 3 mm or less in a direction normal to said light exit plane.

Further, it is preferred that said light guide plate is a flat sheet.

Alternatively, it is preferred that a thickness of said light guide plate gradually increases with the increasing distance from said light entrance plane.

Further, it is preferred that said light exit plane of said light guide plate is a concave plane.

Further, it is preferred that said at least one light entrance plane comprises two light entrance planes provided adjacent two opposite sides of said light exit plane, respectively.

Alternatively, it is preferred that said at least one light entrance plane comprises one light entrance plane provided adjacent one side of said light exit plane.

Further, it is preferred that said distribution density of said transmittance adjusting members changes continuously in such a way that said distribution density once decreases with the increasing distance from said light entrance plane, secondly increases with the increasing distance and then remains at a constant level with the increasing distance.

Alternatively, it is preferred that said at least one light entrance plane comprises four light entrance planes provided adjacent four sides of said light exit plane, respectively.

Further, it is preferred that said transmittance adjusting members are distributed on said rear plane of said light guide plate.

The present invention enables emission of light with a high light use efficiency and minimized unevenness in luminance and guidance of the admitted light deep into the light guide plate, achieving luminance that is evenly distributed or a luminance distribution curve that is high in a range near the middle.

### BRIEF DESCRIPTION OF THE INVENTION

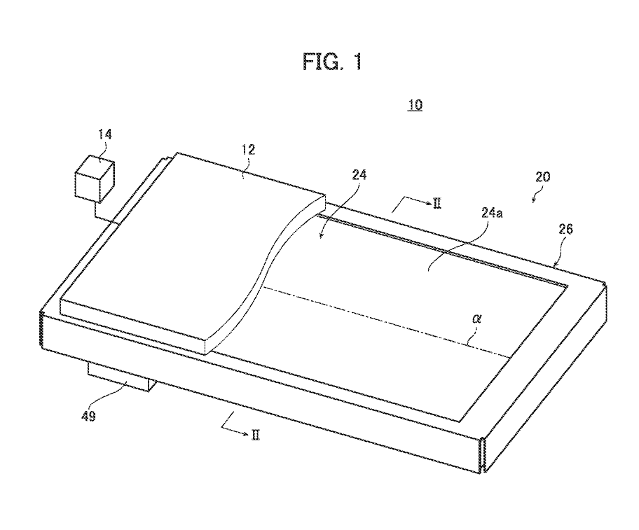

FIG. 1 is a schematic perspective view illustrating an embodiment of a liquid crystal display device using the planar lighting device of the invention.

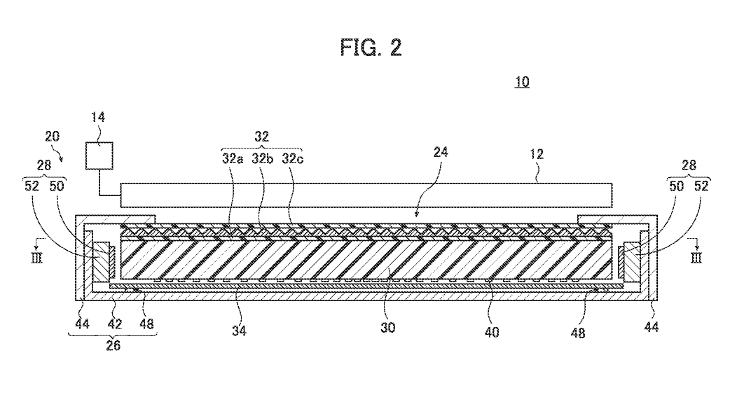

FIG. 2 is a cross sectional view of the liquid crystal display device illustrated in FIG. 1 taken along line II-II.

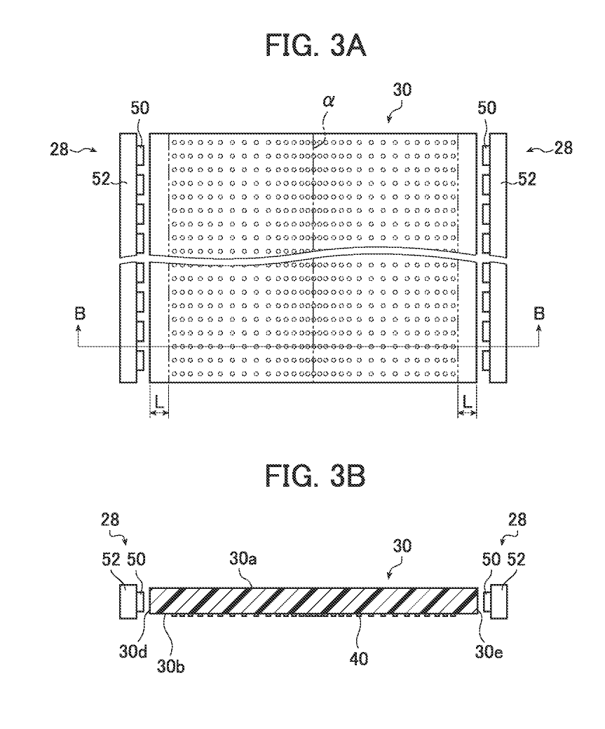

FIG. 3A is a top plan view illustrating, partially omitted, light sources, a light guide plate, and transmittance adjusting members of the planar lighting device of FIG. 2; FIG. 3B is a cross sectional view of FIG. 3A taken along line B-B.

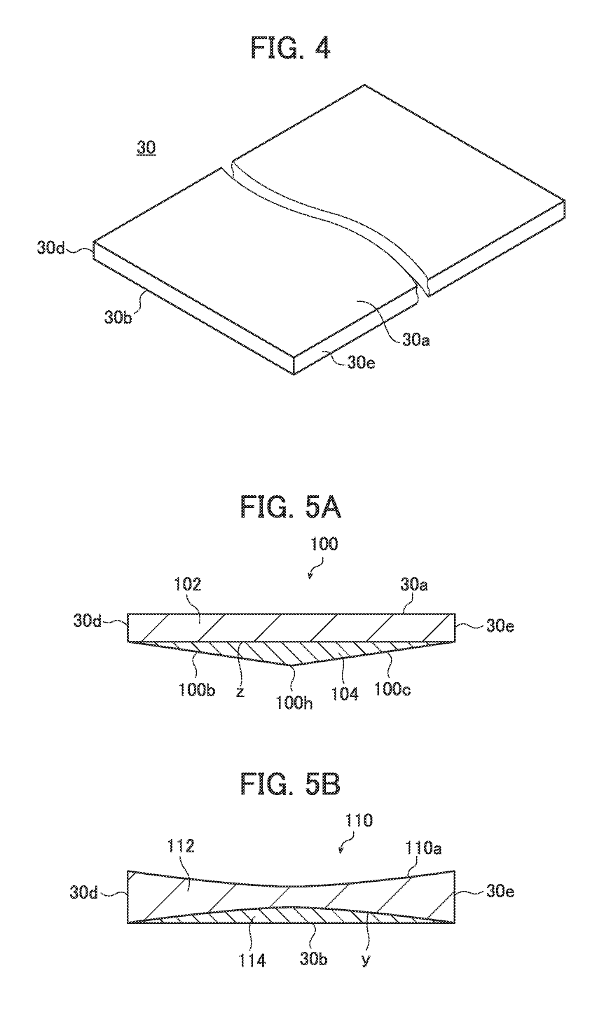

FIG. 4 is a perspective view illustrating the shape of the light guide plate of FIG. 3.

FIGS. 5A and 5B are schematic sectional views illustrating other examples of the light guide plate used in the invention.

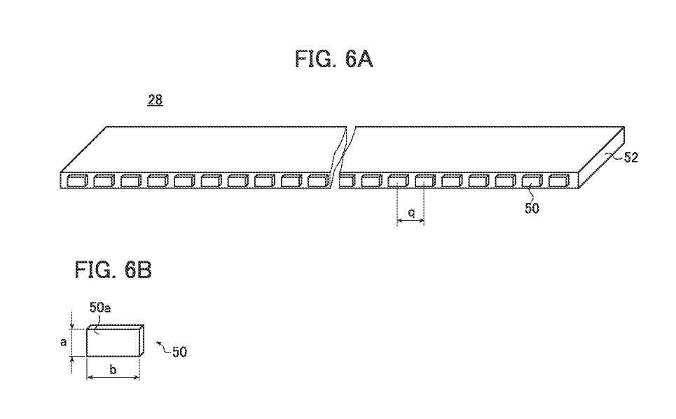

FIG. 6A is a perspective view illustrating the schematic configuration of a light source of the planar lighting device of FIG. 2; FIG. 6B is a schematic perspective view illustrating, enlarged, one of the LEDs forming the light source of FIG. 6A.

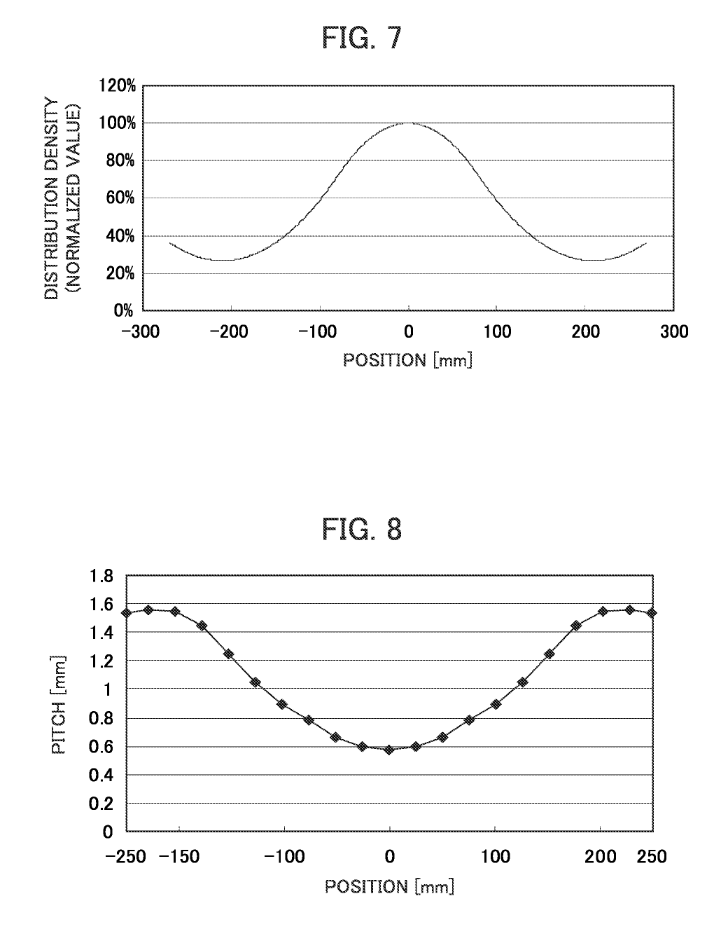

FIG. 7 is a graph illustrating a distribution density of transmittance adjusting members used in the planar lighting device of FIG. 2.

FIG. 8 is a graph illustrating the distribution of space intervals of transmittance adjusting members.

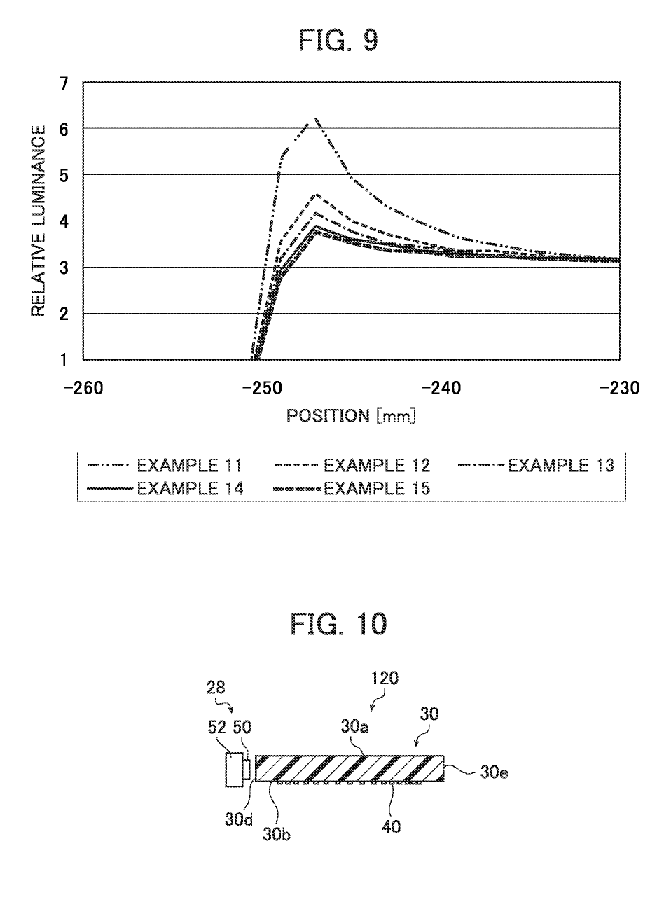

FIG. 9 is a graph illustrating measurements of illuminance distribution of light emitted through the light exit plane of the planar lighting device.

FIG. 10 is a schematic sectional view illustrating a part of an example of the planar lighting device of the invention

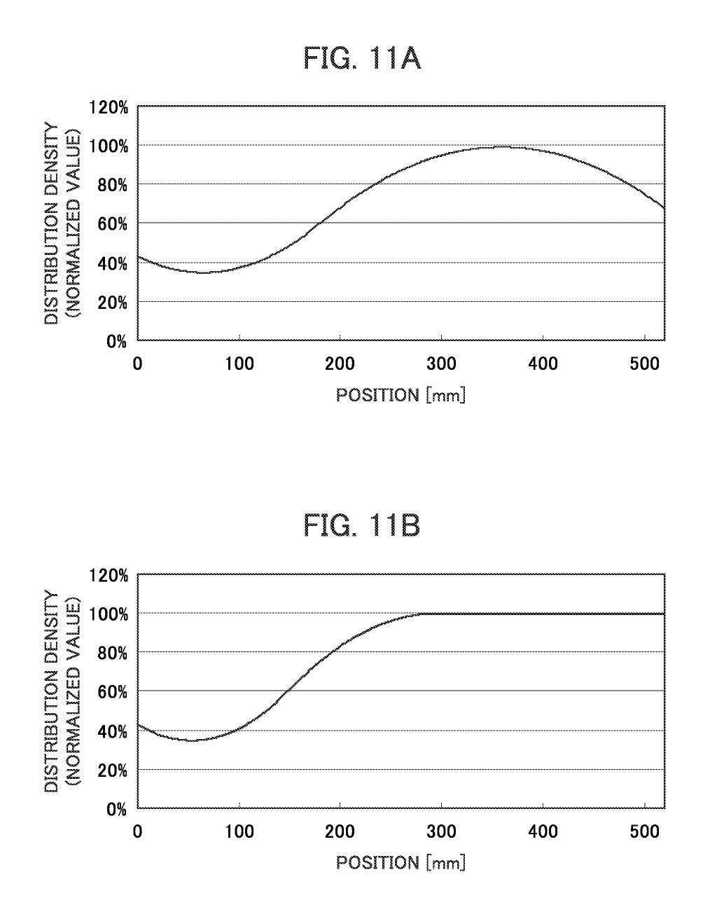

FIG. 11A is a graph illustrating a distribution density of transmittance adjusting members used in the planar lighting device of FIG. 10; FIG. 11B is a graph illustrating another example of the distribution density of the transmittance adjusting members.

### DETAILED DESCRIPTION OF THE INVENTION

Now, the planar lighting device of the invention will be described in detail below referring to preferred embodiments illustrated in the accompanying drawings.

FIG. 1 is a schematic perspective view illustrating a liquid crystal display device provided with the planar lighting device of the invention; FIG. 2 is a cross-sectional view of the liquid crystal display device illustrated in FIG. 1 taken along line II-II.

FIG. 3A is a view of an example of the planar lighting device (also referred to as “backlight unit” below) illustrated in FIG. 2 taken along line III-III; FIG. 3B is a cross sectional view of FIG. 3A taken along line B-B.

A liquid crystal display device 10 comprises a backlight unit 20, a liquid crystal display panel 12 disposed on the side of the backlight unit closer to the light exit plane, and a drive unit 14 for driving the liquid crystal display panel 12. In FIG. 1, a part of the liquid crystal display panel 12 is not shown to illustrate the configuration of the backlight unit.

In the liquid crystal display panel 12, an electric field is partially applied to liquid crystal molecules, previously arranged in a given direction, to change the orientation of the molecules. The resultant changes in refractive index in the liquid crystal cells are used to display characters, figures, images, etc., on the liquid crystal display panel 12.

The drive unit 14 applies a voltage to transparent electrodes in the liquid crystal display panel 12 to change the orientation of the liquid crystal molecules, thereby controlling the transmittance of the light transmitted through the liquid crystal display panel 12.

The backlight unit 20 is a lighting device for illuminating the whole surface of the liquid crystal display panel 12 from behind the liquid crystal display panel 12 and comprises a light exit plane 24a having substantially a same shape as an image display surface of the liquid crystal display panel 12.

As illustrated in FIGS. 1, 2, 3A and 3B, this embodiment of the backlight unit 20 comprises a main body of the lighting device 24 and a housing 26. The main body of the lighting device 24 comprises light sources 28, a light guide plate 30, an optical member unit 32, a reflection film 34, and transmittance adjusting members 40. The housing 26 comprises a lower housing 42, an upper housing 44, and support members 48. As illustrated in FIG. 1, a power unit casing 49 is provided on the underside of the lower housing 42 to hold power supply units that supply the light sources 28 with electrical power.

Now, component parts constituting the backlight unit 20 will be described.

The main body of the lighting device 24 comprises the light sources 28 for emitting light, the light guide plate 30 for admitting the light emitted by the light sources 28 to produce planar light, the optical member unit 32 for scattering and diffusing the light produced by the light guide plate 30 to obtain light with further reduced unevenness, numerous transmittance adjusting members 40 for emitting scattered light and reducing unevenness, and the reflection film 34 for reflecting light leaking from the rear plane of the light guide plate and causing the light to re-enter the light guide plate 30.

First, the light guide plate 30 will be described.

FIG. 4 is a perspective view schematically illustrating the shape of the light guide plate.

As illustrated in FIGS. 2, 3A, 3B, and 4, the light guide plate 30 comprises the flat, rectangular light exit plane 30a; two light entrance planes, the first light entrance plane 30d and the second light entrance plane 30e formed on the two longer sides of the light exit plane 30a and substantially normal to the light exit plane 30a; and an inclined plane 30b located on the opposite side from the light exit plane 30a.

The light guide plate 30 is formed of a transparent resin. The light guide plate 30 preferably contains light scattering particles kneaded and evenly dispersed in the whole light guide plate 30 for scattering light. Transparent resin materials that may be used to form the light guide plate 30 include optically transparent resins such as PET (polyethylene terephthalate), PP (polypropylene), PC (polycarbonate), PMMA (polymethyl methacrylate), benzyl methacrylate, MS resins, and COP (cycloolefin polymer). The scattering particles kneaded and dispersed into the light guide plate 30 may be formed, for example, of fine particles including silicone particles such as TOSPEARL (trademark), silica particles, zirconia particles, or dielectric polymer particles.

Reduction in thickness of the light guide plate 30 in the direction normal to the light exit plane 30a for reduced thickness and weight may allow the transmittance adjusting members 40 to reflect in the emitted light, possibly causing unevenness in luminance. However, kneading and dispersing scattering particles inside the light guide plate 30 cause the light guided through the light guide plate 30 to be scattered and thus enables emission of light through the light exit plane 30a without the transmittance adjusting members 40 to reflect in the emitted light (free from unevenness in luminance) even when the light guide plate 30 is reduced in thickness to 3 mm or less.

The light guide plate according to this embodiment has the shape of a flat sheet but is not limited to this configuration; the rear plane thereof may be inclined with respect to the light exit plane.

For example, the light guide plate may be shaped like a reversed wedge wherein the rear plane is composed of two inclined planes inclined with respect to the light exit plane so that the thickness increases toward the center from the light entrance planes (30d and 30e).

Although the light exit plane of the light guide plate is a flat plane, it is not limited thereto and may be a concave plane. Should the light guide plate contract due to heat and humidity, the configuration of the light exit plane in the form of a concave plane prevents the light guide plate from warping toward the light exit plane and touching the liquid crystal display panel.

According to this embodiment, the particle density of the scattering particles kneaded and dispersed into the light guide plate are evenly dispersed in the light guide plate as described above, but this is not the sole case; the light guide plate may comprise a plurality of layers containing scattering particles with different particle densities.

With the light guide plate comprising a plurality of layers having different scattering particle densities, the particle densities in the individual regions of the light guide plate in the direction normal to the light entrance plane can be adjusted independently of each other and, hence, light can be emitted through the light exit plane with a more desirable luminance distribution.

FIGS. 5A and 5B are schematic sectional views illustrating other examples of light guide plate used in the present invention. A light guide plate 100 illustrated in FIG. 5A and a light guide plate 110 illustrated in FIG. 5B share the same reference characters for the same components as the light guide plate 30 illustrated in FIG. 3. In the following, the description will be focused on different components.

The light guide plate 100 illustrated in FIG. 5A comprises two inclined planes (a first inclined plane 100b and a second inclined plane 100c) located on the opposite side from the light exit plane 30a, i.e., on the underside of the light guide plate 100 so as to be symmetrical to each other with respect to the central axis or the bisector α connecting the centers of the shorter sides of the light guide plate 30a (see FIGS. 1 and 3) and inclined a given angle θ with respect to the light exit plane 30a. The two inclined planes (first inclined plane 100b and second inclined plane 100c) are smoothly connected to each other by a curved portion 100h having a radius of curvature R.

The thickness of the light guide plate 100 increases from the first light entrance plane 30d and the second light entrance plane 30e toward the center such that the light guide plate 30 is thickest in a position thereof corresponding to the central bisector α and thinnest at the two light entrance planes (the first light entrance plane 30d and the second light entrance plane 30e) on both ends.

Thus, the reversed wedge-shaped configuration having the light guide plate growing thicker with the increasing distance from the light entrance planes enables the light to be guided deep into the light guide plate, so that the light can be emitted through the light exit plane with a more desirable luminance distribution.

The light guide plate 100 comprises a first layer 102 on the side of an interface z closer to the light exit plane 30a and a second layer 104 on the side of the interface z closer to the rear plane, the interface z connecting the ends of the light entrance planes (30d, 30e) bordering on the rear plane, and these two layers contain scattering particles kneaded and dispersed therein with different particle densities. The second layer 104 has a higher scattering particle density than the first layer 102. Thus, the light guide plate, comprising a plurality of layers containing scattering particles with different densities, is capable of emitting light with a more desirable luminance distribution and yielding an increased light use efficiency.

The light guide plate 110 illustrated in FIG. 5B, shaped like a flat sheet, has a concave light exit plane and comprises two layers containing scattering particles with different densities.

The light guide plate 110 has the light exit plane 110a formed into a concave plane, i.e., into a shape further approaching the rear plane 30b with the increasing distance from the light entrance planes (30d, 30e). The light guide plate 110 comprises a first layer 112 on the side of an interface y closer to a light exit plane 110a and a second layer 114 on the side closer to the rear plane 30b, the interface y being a curved plane so shaped as to be farther distanced from the rear plane 30b with the increasing distance from the ends of the sides of the light entrance planes (30d, 30e) bordering on the rear plane 30b toward the center of the light guide plate 30. The scattering particles are so dispersed that the second layer 114 has a higher particle density than the first layer 112.

Thus, the light guide plate formed into a flat sheet can be adapted to have larger light entrance planes and yield an increased light use efficiency. Should the light guide plate contract due to heat and humidity, the configuration of the light exit plane in the form of a concave plane prevents the light guide plate from warping toward the light exit plane and touching the liquid crystal display panel.

Further, the two-layer structure having different particle densities such that the thickness of the second layer having a higher particle density increases from the light entrance planes toward the center of the light guide plate enables a desirable luminance distribution to be achieved even when the light guide plate has the form of a flat sheet.

To emit light exhibiting a luminance distribution curve that is high in a range near the middle through the light exit plane, placing the particle density of the scattering particles contained in the light guide plate in the following range is also preferable.

Now, let Φ be a scattering cross section of the particles contained in the light guide plate 30; L_{G} a light guiding length in the incident direction, which is the distance between the light entrance planes of the light guide plate according to this embodiment; Nₚ a density of the scattering particles contained in the light guide plate 30 (number of particles per volume); and K_{C} a compensation coefficient. Then, the scattering particles preferably satisfy a relationship where the value of Φ·Nₚ·L_{G}·K_{C} is greater than or equal to 1.1 and less than or equal to 8.2, and the value of the compensation coefficient K_{C} is greater than or equal to 0.005 and less than or equal to 0.1. The light guide plate 30, containing scattering particles satisfying the above relationship, is capable of emitting uniform light through the light exit plane with a greatly reduced level of unevenness in luminance.

The value Φ·Nₚ·L_{G}·K_{C} is preferably in a range of 2.0 inclusive to 7.0 inclusive, more preferably not less than 3.0 and still more preferably not less than 4.7.

The light guide plate may be fabricated by mixing a plasticizer into a transparent resin of the light guide plate.

Fabricating the light guide plate from a material thus prepared by mixing a transparent resin and a plasticizer provides a flexible light guide plate, allowing the light guide plate to be deformed into various shapes. Accordingly, the surface of the light guide plate can be formed into various curved surfaces.

Where the light guide plate is given such flexibility, a backlight unit using the light guide plate as described above can even be mounted to a wall having a curvature when used, for example, for a display board employing ornamental lighting (illuminations). Accordingly, the backlight unit can be used for a wider variety of applications and in a wider application range including ornamental lighting and POP (point-of-purchase) advertising.

Said plasticizer is exemplified by phthalic acid esters, or, specifically, dimethyl phthalate (DMP), diethyl phthalate (DEP), dibutyl phthalate (DBP), di(2-ethylhexyl) phthalate (DOP (DEHP)), di-n-octyl phthalate (DnOP), diisononyl phthalate (DINP), dinonyl phthalate (DNP), diisodecyl phthalate (DIDP), phthalate mixed-base ester (C6 to C11) (610P, 711P, etc.) and butyl benzyl phthalate (BBP). Besides phthalic acid esters, said plasticizer is also exemplified by dioctyl adipate (DOA), diisononyl adipate (DINA), dinormal alkyl adipate (C6, 8, 10) (610A), dialkyl adipate (C7, 9) (79A), dioctyl azelate (DOZ), dibutyl sebacate (DBS), dioctyl sebacate (DOS), tricresyl phosphate (TCP), tributyl acetylcitrate (ATBC), epoxidized soybean oil (ESBO), trioctyl trimellitate (TOTM), polyesters, and chlorinated paraffins.

Now, the light source 28 will be described.

FIG. 6A is a schematic perspective view illustrating a configuration of a light source 28 of the backlight unit 20 of FIGS. 1 and 2; FIG. 6B is a schematic perspective view illustrating, enlarged, only one LED chip of the light source 28 of FIG. 6A.

As illustrated in FIG. 6A, the light source 28 comprises a plurality of light emitting diode chips (referred to as “LED chips” below) 50 and a light source mount 52.

The LED chip 50 is a chip of a light emitting diode emitting blue light the surface of which has a fluorescent substance applied thereon. It has a light emission surface 50a with a given area through which white light is emitted.

Specifically, when blue light emitted through the surface of the light emitting diode of the LED chip 50 is transmitted through the fluorescent substance, the fluorescent substance generates fluorescence. Thus, the blue light emitted by the light emitting diode and the light emitted as the fluorescent substance fluoresces blend to produce white light from the LED chip 50.

The LED chip 50 may for example be formed by applying a YAG (yttrium aluminum garnet) base fluorescent substance to the surface of a GaN base light emitting diode, an InGaN base light emitting diode, and the like.

A light source support 52 is a plate member disposed such that one surface thereof faces the light entrance plane 30d or 30e, which is a lateral end face of the light guide plate 30.

The light source support 52 carries the LED chips 50 on its lateral plane (30d or 30e) facing the light entrance plane of the light guide plate 30 so that the LED chips 50 are spaced at given intervals from each other. Specifically, the LED chips 50 constituting the light source 28 are arrayed along the length of the first light entrance plane 30d or the second light entrance plane 30e of the light guide plate 30 to be described and secured to a light source support 52.

The light source support 52 is preferably formed of a metal having a good conductivity such as copper and aluminum. The light source support 52 formed of a metal having a good heat conductivity as exemplified by copper and aluminum acts as a heat sink to absorb heat generated by the LED chips 50 and release the heat to the outside. The light source support 52 may be equipped with fins to provide a larger surface area for an increased heat dissipation effect or heat pipes to transfer heat to a heat dissipation member.

As illustrated in FIG. 6B, the LED chips 50 according to this embodiment each preferably have a rectangular shape such that the sides normal to the direction in which the LED chips 50 are arrayed are shorter than the sides lying in the direction in which the LED chips 50 are arrayed. Thus, the length “a” of the side of the LED chips 50 perpendicular to the light exit plane 30a of the light guide plate 30, the length “b” of the side in the array direction, and the distance “q” by which the arrayed LED chips 50 are spaced apart from each other preferably have a relationship satisfying q>b>a, where q is the space interval at which the LED chips 50 are arrayed.

Providing the LED chips 50 each having the shape of a rectangle allows a thinner design of the light source to be achieved while producing a large amount of light. A thinner light source 28, in turn, permits reduction of thickness of the backlight unit. Further, the number of LED chips that need to be arranged may be reduced.

While the LED chips 50 each preferably have a rectangular shape with the shorter sides lying in the direction of the thickness of the light guide plate 30 for a thinner design of the light source 28, the present invention is not limited thereto, allowing the LED chips to have any shape as appropriate such as a square, a circle, a polygon, and an ellipse.

Next, the transmittance adjusting members 40 will be described.

The transmittance adjusting members 40 are each formed of a circular dot having a given transmittance and provided to diffuse the light admitted through the light entrance planes of the light guide plate 30 and emit the light through the light exit plane 30a and also to reduce the unevenness in the emitted light. As illustrated in FIGS. 2 and 3, a plurality of the transmittance adjusting members 40 are provided in a given pattern by printing or other means on the rear plane 30b of the light guide plate 30.

FIG. 7 is a graph illustrating a distribution density in the direction normal to the light entrance planes (30d and 30e) with which the transmittance adjusting members 40 are provided. The graph indicates a normalized value of the distribution density of the transmittance adjusting members 40 on the vertical axis and the distance [mm] from the center of the light guide plate on the horizontal axis.

As illustrated in FIG. 7, the distribution density of the transmittance adjusting members 40 continuously changes, once decreasing with the increasing distance from the light entrance planes 30d and 30e, and then increasing again. Specifically, the distribution density of the transmittance adjusting members 40 continuously changes, peaking at the center of the light guide plate 30 (bisector α) in the direction normal to the light entrance planes, then continuously decreasing toward the first light entrance plane 30d and the second light entrance plane 30e, thereafter increasing again near the first light entrance plane 30d and the second light entrance plane 30e.

Thus, the density profile of the distribution pattern of the transmittance adjusting members 40 peaks at the center of the light guide plate 30 and reaches a minimum at points on both sides thereof that are located at about ⅔ of the distance from the center to the light entrance planes (30d and 30e) in the illustrated example.

With the transmittance adjusting members 40 so distributed that the distribution density changes continuously, once decreasing with the increasing distance from the light entrance planes 30d and 30e, and then increasing again, light admitted through the light entrance planes 30d and 30e and traveling parallel to the light exit plane 30a can be diffused near the light entrance plane, and an abrupt change in luminance distribution of the emitted light can be prevented, while the admitted light can be guided deep into the light guide plate, with the result that light can be emitted through the light exit plane 30a with a smooth and uniform luminance distribution curve that is high in a range near the middle while the light use efficiency can also be improved.

The diffusion of light by the transmittance adjusting members 40 has a directionality normal to the light exit plane 30a and can improve the front luminance of the emitted light.

The distribution density of the transmittance adjusting members 40 may be adjusted by varying the size (area) of the transmittance adjusting members 40 according to their positions or by adjusting the space interval (pitch) between the adjacent transmittance adjusting members 40 as appropriate. In the illustrated example, the transmittance adjusting members 40 all have the same size and their distribution density is adjusted by varying the space interval.

In varying the space interval of the transmittance adjusting members 40, it is preferable that the transmittance adjusting members 40 are spaced from adjacent members at random intervals, with a mean distribution density set to the above distribution density.

Distributing the transmittance adjusting members 40 so as to be spaced from adjacent members at random intervals prevents the transmittance adjusting members 40 from reflecting in the light emitted through the light exit plane 30a.

The transmittance adjusting members 40 may be scattering reflection members and formed, for example, of pigments such as silica, titanium oxide, and zinc oxide that diffuse light, or a coating containing a kind of beads such as resin, glass, and zirconia, as well as a binder, and a roughened surface pattern produced by applying fine asperity machining or polishing to the surface. Alternatively, one may use materials having a high reflectance and a low light absorbance, including metals such as Ag and Al.

Alternatively, common white ink such as ink used for screen printing and offset printing may be used to form the transmittance adjusting members 40. Examples thereof include ink prepared by dispersing titanium oxide, zinc oxide, zinc sulfate, barium sulfate, or the like into an acryl-based binder, a polyester-based binder, chloroethene-based binder, or the like, or ink prepared by mixing silica with titanium oxide to provide diffusivity.

Further, each of the transmittance adjusting members 40 preferably have an area of 0.1 mm² or less. With the transmittance adjusting members 40 each given an area of 0.1 mm² or less, light can be emitted through the light exit plane 30a without the transmittance adjusting members 40 reflecting in the light even when the light guide plate 30 is thin, with a thickness of not greater than 3 mm.

As a preferred embodiment, the illustrated example of the backlight unit comprises marginal regions near the light entrance planes 30d and 30e of the light guide plate where no transmittance adjusting members 40 are provided.

Specifically, as illustrated in FIG. 3A, the marginal regions extend over a distance of L from the first light entrance plane 30d and the second light entrance plane 30d. These regions contain no transmittance adjusting members 40.

As described above, the diffusion by the transmittance adjusting members 40 has a directionality in the direction of the light exit plane. Thus, providing the transmittance adjusting members near the light entrance planes may increase return light, which is the light that is admitted through the light entrance planes and then returns toward the light entrance planes to exit through the light entrance planes. Increase of the return light reduces the amount of light emitted through the light exit plane and hence the light use efficiency as well.

In contrast, provision of the marginal regions containing no transmittance adjusting members 40 near the light entrance planes 30d and 30e prevents the light scattered by the transmittance adjusting members 40 from exiting through the light entrance planes 30d and 30e as return light and prevents the light use efficiency from decreasing.

Further, such a configuration enables the light admitted through the light entrance planes 30d and 30e to be scattered before being scattered in the direction of the light exit plane 30a by the transmittance adjusting members 40, i.e., before the light is emitted through the light exit plane 30a, and therefore prevents occurrence of a bright line attributable to the space intervals of the light source units of the light source 28.

In a typical backlight unit, the end portions of the light exit plane are covered by a housing and the light emitted from these covered portions is not used. Therefore, providing marginal regions emitting little light and increasing the light emission amount near the center of the light guide plate enables improvement in the light use efficiency.

While there is no specific limitation to the size of the marginal regions containing no transmittance adjusting members 40, i.e., the distance L (the length of the marginal regions) from the light entrance planes 30d and 30e, the distance L is preferably 20 mm or greater, and more preferably 30 mm or greater.

A configuration having the marginal regions extending over the distance L of 30 mm or greater reduces the return light more desirably and causes the light to be scattered more desirably, thus achieving more uniform luminance distribution and yielding improved light use efficiency.

Now, the size of the marginal regions will be described in greater detail by referring to specific examples.

In this embodiment, a computer simulation was conducted on the illustrated backlight unit 20 to obtain normalized illuminance distribution of emitted light.

### Example 1

The backlight unit 20 used in an example 1 had dimensions corresponding to a 40-inch screen. The emission surface of the backlight unit 20 corresponding to a 40-inch screen has a length of 499 mm in the direction normal to the light entrance planes.

Specifically, a model of the light guide plate 30 used in the simulation was a flat light guide plate made of a base material PMMA containing silicone scattering particles kneaded and dispersed therein. The light guide plate 30 was 1 mm thick; the scattering particles had a diameter of 4.5 μm.

A model of the light source 28 comprised LED chips each measuring 1.5 mm×2.6 mm arrayed at a pitch of 7 mm. For easy comparison, the simulation used only one light source 28, admitting light only through the first light entrance plane 30d and not admitting light through the second light entrance plane 30e.

The transmittance adjusting members 40 were provided by forming concave dots having a diameter of 0.05 mm on the rear side 30b of the light guide plate 30 in a region corresponding to the emission surface of the backlight unit 20. The space interval of the transmittance adjusting members 40 (pitch) was varied as illustrated in FIG. 8 to adjust the distribution density. FIG. 8 indicates the distance [mm] from the center of the light guide plate on the horizontal axis in the direction normal to the light entrance planes 30d and 30e and a pitch between the adjacent transmittance adjusting members 40 on the vertical axis

Using the backlight unit 20 having the above shape, the luminance distribution was measured with the following examples: Example 11 where the light guide plate 30 had a length of 519 mm in the direction normal to the light entrance plane (length of the light guide plate) and a marginal region length L of 10 mm;

Example 12 where the light guide plate had a length of 539 mm and a marginal region length L of 20 mm;

Example 13 where the light guide plate had a length of 549 mm and a marginal region length L of 25 mm;

Example 14 where the light guide plate had a length of 559 mm and a marginal region length L of 30 mm; and

Example 15 where the light guide plate had a length of 569 mm and a marginal region length L of 35 mm. The normalized luminance illustration thus measured are illustrated in FIG. 9.

The normalized luminance distributions are illustrated in FIG. 9. In FIG. 9, the vertical axis indicates the normalized illuminance, and the horizontal axis indicates the distance [mm] from the center of the light guide plate. In the graph, the example 11 is indicated in a chain double-dashed line, the example 12 in a thin broken line, the example 13 in a chain line, the example 14 in a thin solid line, and the example 15 in a bold broken line.

As illustrated in FIG. 9, when the marginal region length is 20 mm or longer, luminance unevenness near the light entrance plane can be reduced desirably; when the marginal region length is 30 mm or longer, luminance unevenness near the light entrance plane can be reduced more desirably.

The transmittance adjusting members 40 of the backlight unit 20 in the illustrated example have a circular shape according to this embodiment but may have any shape as appropriate according to the invention such as a rectangle, a triangle, a hexagon, a circle, and an ellipse.

The transmittance adjusting members according to this embodiment are provided on the rear plane of the light guide plate but the invention is not limited to this configuration, and they may be provided on the light exit plane of the light guide plate.

Further, the position where the transmittance adjusting members 40 are provided is not limited to the surfaces of the light guide plate; the transmittance adjusting members may be arranged on a transparent film and this transparent film may be provided on the rear side or the light exit plane side of the light guide plate, or alternatively may be arranged on a reflection film or a sheet constituting the optical member units.

Next, the optical member unit 32 will be described.

The optical member units 32 are provided to further reduce the unevenness in luminance and unevenness in illuminance of the illumination light emitted through the light exit plane 30a of the light guide plate 30 before the illumination light is emitted through the light exit plane 24a of the main body of the lighting device 24. As illustrated in FIG. 2, the optical member unit 32 comprises a diffusion sheet 32a for diffusing the illumination light emitted through the light exit plane 30a of the light guide plate 30 to reduce unevenness in luminance and unevenness in illuminance; a prism sheet 32b having micro prism arrays formed thereon parallel to the lines where the light exit plane 30a and the light entrance planes 30d, 30e meet; and a diffusion sheet 32c for diffusing the illumination light emitted through the prism sheet 32b to reduce unevenness in luminance and unevenness in illuminance.

The diffusion sheets 32a and 32c and the prism sheet 32b are not specifically limited and may be known diffusion sheets and a known prism sheet. The diffusion sheets 20a and 20c and the prism sheet 20b may be, for example, the diffusion sheets and the prism sheet disclosed in paragraphs [0028] through [0033] of JP 2005-234397 A by the Applicant of the present application.

While the optical member unit in the embodiment under discussion comprises the two diffusion sheets 32a and 32c and the prism sheet 32b between the two diffusion sheets, there is no specific limitation to the order in which the prism sheet and the diffusion sheets are arranged or the number thereof to be provided. Nor are the prism sheet and the diffusion sheets specifically limited, and use may be made of various optical members, provided that they are capable of reducing the unevenness in luminance and unevenness in illuminance of the illumination light emitted through the light exit plane 30a of the light guide plate 30.

Further, the optical member unit may be adapted to have a two-layer structure formed using one sheet each of the prism sheet and the diffusion sheet or two diffusion sheets only.

Next, the reflection film 34 will be described.

The reflection film 34 is provided to reflect light leaking through the rear plane 30b of the light guide plate 30 back into the light guide plate 30 and helps enhance the light use efficiency. The reflection film 34 has a shape corresponding to the rear plane 30b of the light guide plate 30 and is formed so as to cove the rear plane 30b. In this embodiment, the reflection film 34 is formed into a shape contouring the profile of the rear plane 30b of the light guide plate 30 having a flat plane in cross section as illustrated in FIG. 2.

The reflection film 34 may be formed of any material as desired, provided that it is capable of reflecting light leaking through the rear plane of the light guide plate 30. The reflection film 34 may be formed, for example, of a resin sheet produced by kneading, for example, PET or PP (polypropylene) with a filler and then drawing the resultant mixture to form voids therein for increased reflectance; a sheet with a specular surface formed by, for example, depositing aluminum vapor on the surface of a transparent or white resin sheet; a metal foil such as an aluminum foil or a resin sheet carrying a metal foil; or a thin sheet metal having a sufficient reflective property on the surface.

Next, the housing 26 will be described.

As illustrated in FIG. 2, the housing 26 accommodates and supports therein the main body of the lighting device 24 by holding the sides of the light guide plate facing the light exit plane and the rear plane to secure the main body of the lighting device. The housing 26 comprises the lower housing 42, the upper housing 44, and the support members 48.

The lower housing 42 has substantially the shape of a rectangular box open on one side. As illustrated in FIG. 2, the bottom side and the lateral sides of the housing 42 support the lighting device 24 placed therein from above on the underside and on the lateral sides and covers the faces of the lighting device 24 except the light exit plane 24a, i.e., the plane opposite from the light exit plane 24a of the lighting device 24 (rear plane) and the lateral sides.

The upper housing 44 has the shape of a rectangular box; it has an opening at the top smaller than the rectangular light emission plane 24a of the main body of the lighting device 24 and is open on the bottom side.

As illustrated in FIG. 2, the upper housing 44 is placed from above the main body of the lighting device 24 and the lower housing 42, that is, from the light exit plane side, to cover the main body of the lighting device 24 and the lower housing 42, which holds the former, as well as four lateral sections 22b.

The support members 48 are rod members each having an identical cross section normal to the direction in which they extend throughout their length.

As illustrated in FIG. 2, the support members 48 are provided between the reflection film 34 and the lower housing 42, more specifically, between the reflection film 34 and the lower housing 42 close to the end of the rear plane 30b of the light guide plate 30 where the first light entrance plane 30d is located and close to the end of the rear plane 30b where the second light entrance plane 30e is located. The support members 48 thus secure the light guide plate 30 and the reflection film 34 to the lower housing 42 and support them.

The backlight unit 20 is basically configured as described above.

In the backlight unit 20, light emitted by the light sources 28 provided on both sides of the light guide plate 30 strikes the light entrance planes, i.e., the first light entrance plane 30d and the second light entrance plane 30e, of the light guide plate 30. Then, the light admitted through the respective planes is scattered by the scatterers contained inside the light guide plate 30 in the region near the light entrance planes and by the scatterers and the transmittance adjusting members 40 in the region provided with the transmittance adjusting members 40, as the light travels through the inside of the light guide plate 30 and exits, directly or after being reflected by the rear plane 30b through the light exit plane 30a. A part of the light leaking through the rear plane 30b is reflected by the reflection film 34 to enter the light guide plate 30 again.

Thus, light emitted through the light exit plane 30a of the light guide plate 30 is transmitted through the optical member 32 and emitted through the light emission plane 24a of the main body of the lighting device 24 to illuminate the liquid crystal display panel 12.

The liquid crystal display panel 12 uses the drive unit 14 to control the transmittance for the light according to the position so as to display characters, figures, images, etc. on its surface.

Although the light guide plate according to the above embodiments is of a type comprising two light sources disposed adjacent two light entrance planes of the light guide plate to admit light through both sides of the light guide plate, the invention is not limited to such a configuration; the light guide plate may also comprise light sources on the shorter sides of the light exit plane of the light guide plate in addition to those provided adjacent the two light entrance planes. Increasing the number of light sources permits enhancing the intensity of light emitted by the light guide plate.

Alternatively, the light guide plate may comprise a single light source disposed adjacent one light entrance plane to admit light through one side of the light guide plate.

FIG. 10 is a schematic sectional view illustrating a part of another example of the backlight unit of the invention; FIG. 11A is a graph illustrating a density distribution of the transmittance adjusting members used in the backlight unit shown in FIG. 10. In these graphs, the vertical axis indicates the normalized value of the distribution density of the transmittance adjusting members 40, and the horizontal axis indicates the distance [mm] from the first light entrance plane 30d. A backlight unit 120 illustrated in FIG. 10 has the same configuration as the backlight unit 20 illustrated in FIG. 2 except that the former is provided with only a single light source 28 and has a different distribution density of the transmittance adjusting members 40. In the following, like components will be given like characters, and the description will be focused on the components different between these backlight units.

The backlight unit 120 illustrated in FIG. 10 has the light source 28 only adjacent the first light entrance plane 30d and does not have the light source 28 adjacent the second light entrance plane 30e. The transmittance adjusting members 40 of such a backlight unit 120 has a distribution density as illustrated in FIG. 11A that changes continuously, once decreasing with the increasing distance from the light entrance plane 30d, and then increasing, before decreasing again toward the second light entrance plane 30e.

Thus, the density profile of the distribution pattern of the transmittance adjusting members 40 has a characteristics curve having a minimum value at a position closer to the first light entrance plane 30d and peaks at a position closer to the second light entrance plane 30e.

Thus, where light is admitted through only one side of the light guide plate, with the transmittance adjusting members 40 so distributed that the distribution density changes continuously, once decreasing with the increasing distance from the light entrance plane 30d before increasing again, light admitted through the light entrance plane 30d traveling parallel to the light exit plane 30a can be diffused near the light entrance plane, and abrupt change in the luminance distribution of the emitted light can be prevented, while the admitted light can be guided deep into the light guide plate, with the result that light can be emitted through the light exit plane 30a with a smooth and uniform luminance distribution curve that is high in a range near the middle while the light use efficiency can also be improved.

Although with the backlight unit 120 illustrated in FIG. 10, the transmittance adjusting members 40 are provided with a distribution density changing in a curved line as illustrated in FIG. 11A, the invention permits other characteristics lines as well such as one including a linearly changing portion.

FIG. 11B illustrates another example of distribution density of the transmittance adjusting members 40 for a backlight unit with one-sided light admission: the graph indicates a normalized value of the distribution density of the transmittance adjusting members 40 on the vertical axis and the distance [mm] from the first light entrance plane 30d on the horizontal axis.

As illustrated in FIG. 11B, the distribution density of the transmittance adjusting members 40 changes continuously, once decreasing with the increasing distance from the first light entrance plane 30d, and then increasing before remaining at a constant level toward the second light entrance plane 30e.

Thus, the distribution density of the transmittance adjusting members 40 may contain a linearly changing portion in addition to curved changes.

While the planar lighting device of the invention has been described above in detail, the present invention is not limited in any manner to the above embodiments and various improvements and modifications may be made without departing from the spirit of the invention.

For example, the light guide plate may be adapted to emit light also through the rear plane, the plane opposite from the light exit plane, in addition to the light exit plane, that is, the light guide plate may be adapted to emit light from both sides. The backlight unit, thus adapted to emit light from both sides, can be used for a wider variety of applications including ornamental lighting (illumination) and POP (point-of-purchase) advertising.

We claim:

1. A planar lighting device comprising:
a light guide plate including a light exit plane being rectangular, at least one light entrance plane for admitting light traveling parallel to said light exit plane, said light entrance plane being provided on a side of said light exit plane, and a rear plane opposite to said light exit plane,
at least one light source, said light source being disposed facing to said light entrance plane, respectively and
transmittance adjusting members distributed in a given pattern on a side of said light guide plate closer to said rear plane or on a side closer to said light exit plane, or on both of these sides,
wherein a distribution density of said transmittance adjusting members continuously changes in such a way that said distribution density once decreases with an increasing distance from said light entrance plane, and then increases with the increasing distance.

2. The planar lighting device according to claim 1, wherein said distribution density of said transmittance adjusting members has a minimum value at a position farther from said light entrance plane than a position where said distribution density has a maximum value.

3. The planar lighting device according to claim 1, wherein said transmittance adjusting members are not distributed in a region extending a given distance from an end of said light entrance plane of said light guide plate in a direction normal to said light entrance plane.

4. The planar lighting device according to claim 3, wherein said given distance is 30 mm or more.

5. The planar lighting device according to claim 1, wherein each of said transmittance adjusting members has an area of 0.1 mm² or less.

6. The planar lighting device according to claim 1, wherein said transmittance adjusting members are distributed in a random pattern.

7. The planar lighting device according to claim 1, wherein said light guide plate contains scattering particles dispersed therein.

8. The planar lighting device according to claim 7, wherein it is to satisfy inequality
1.1≦Φ·Nₚ·L_{G}·K_{C}≦8.2,
where Φ is a scattering cross section of said scattering particles dispersed in said light guide plate, Nₚ is a particle density, L_{G} is a light guiding length in a light's incident direction, and K_{c} is a correction coefficient, provided that K_{c} is in a range of 0.005 inclusive to 0.1 inclusive.

9. The planar lighting device according to claim 7, wherein said light guide plate comprises a plurality of layers superposed on each other in a direction normal to said light exit plane and having different densities of said scattering particles.

10. The planar lighting device according to claim 1, wherein said light guide plate has a thickness of 3 mm or less in a direction normal to said light exit plane.

11. The planar lighting device according to claim 1, wherein said light guide plate is a flat plate.

12. The planar lighting device according to claim 1, wherein a thickness of said light guide plate gradually increases with the increasing distance from said light entrance plane.

13. The planar lighting device according to claim 1, wherein said light exit plane of said light guide plate is a concave plane.

14. The planar lighting device according to claim 1, wherein said at least one light entrance plane comprises two light entrance planes provided adjacent two opposite sides of said light exit plane, respectively.

15. The planar lighting device according to claim 1, wherein said at least one light entrance plane comprises one light entrance plane provided adjacent one side of said light exit plane.

16. The planar lighting device according to claim 15, wherein said distribution density of said transmittance adjusting members changes continuously in such a way that said distribution density once decreases with the increasing distance from said light entrance plane, secondly increases with the increasing distance and then remains at a constant level with the increasing distance.

17. The planar lighting device according to claim 1, wherein said at least one light entrance plane comprises four light entrance planes provided adjacent four sides of said light exit plane, respectively.

18. The planar lighting device according to claim 1, wherein said transmittance adjusting members are distributed on said rear plane of said light guide plate.
